(19) United States
(12) Patent Application Publication
(10) Pub. No.: US 2015/0240712 A1
(43) Pub. Date: Aug. 27, 2015

(54) MID-TURBINE DUCT FOR GEARED GAS TURBINE ENGINE

(71) Applicant: United Technologies Corporation, Hartford, CT (US)

(72) Inventors: Renee J. Jurek, Colchester, CT (US); Thomas J. Praisner, Colchester, CT (US)

(21) Appl. No.: 14/608,304

(22) Filed: Jan. 29, 2015

Related U.S. Application Data
(60) Provisional application No. 61/943,519, filed on Feb. 24, 2014.

(51) Int. Cl. F02C 3/06; F01D 9/04; F02C 7/057

(52) U.S. Cl. CPC F02C 3/06; F02C 7/057; F01D 9/045; F05D 2200/14; F05D 2220/32

(57) ABSTRACT

A mid-turbine vaned duct comprises a duct upstream end to abut a downstream end of an upstream turbine rotor. A duct downstream end abuts an upstream end of a downstream turbine rotor. The vaned duct includes a first gap extending between the upstream turbine rotor and an upstream end of a vane positioned within the duct, intermediate the vaned duct upstream and downstream ends. A second gap is defined between a downstream end of the vane and the downstream turbine rotor. The first gap extends for a first axial distance and the second gap extends for a second axial distance. A length ratio of the first axial distance to the second axial distance is less than or equal to 2.0.

### CROSS REFERENCE TO RELATED APPLICATION

This application claims priority to U.S. Provisional Application No. 61/943,519 which was filed on Feb. 24, 2014.

### BACKGROUND OF THE INVENTION

This application relates to a mid-turbine vaned duct for a gas turbine engine wherein a fan rotor is driven through a gear reduction.

Gas turbine engines are known and, typically, include a fan delivering air into a compressor section. The air is compressed and then delivered into a combustion section where it is mixed with fuel and ignited. Products of this combustion pass downstream over turbine rotors driving them to rotate.

In one common type of gas turbine engine, there are two turbines. A higher pressure turbine rotor drives a higher pressure compressor and a lower pressure turbine rotor drives a lower pressure compressor and further drives a fan through a gear reduction. In such an arrangement, the lower pressure turbine is the fan drive turbine.

In another gas turbine engine arrangement, there are three turbines, with a most downstream turbine driving the fan through the gear reduction.

In either arrangement, there is typically a vaned duct between the fan drive turbine and an upstream turbine. The duct has historically included static guide vanes to guide flow. In the prior art, there are standard vaned ducts wherein a bearing for supporting a shaft is included axially within an axial chord of the vane within the duct. Such arrangements require mount or frame structure complex assembly. As an example, structural support members may extend radially through the vanes within said duct.

In a non-structural duct, the bearings for supporting the shafts driven by the turbine rotor are axially positioned outside of this vaned duct. In such vaned ducts, the vane has typically been spaced from a downstream most blade of the upstream turbine rotor and an upstream most blade of the fan drive turbine rotor. The vane has typically been placed much closer to the upstream end of the fan drive turbine, such that a ratio of a gap between the downstream end of the upstream turbine rotor and an upstream end of the vane compared to a gap between a downstream end of the vane and the upstream end of the most upstream blade of the fan drive turbine rotor is on the order of 4.0 or greater.

This is a very large length of circumferentially unconstrained flow, which can result in efficiency losses.

The location of the vanes in a structural duct is decided by other factors than those impacting the location in a non-structural duct.

### SUMMARY OF THE INVENTION

In a featured embodiment, a mid-turbine vaned duct comprises a duct upstream end to abut a downstream end of an upstream turbine rotor. A duct downstream end abuts an upstream end of a downstream turbine rotor. The vaned duct includes a first gap extending between the upstream turbine rotor and an upstream end of a vane positioned within the duct, intermediate the vaned duct upstream and downstream ends. A second gap is defined between a downstream end of the vane and the downstream turbine rotor. The first gap extends for a first axial distance and the second gap extends for a second axial distance. A length ratio of the first axial distance to the second axial distance is less than or equal to 2.0.

In another embodiment according to the previous embodiment, a first radial height (h₁) is measured at the duct upstream end. A second radial height (h₂) is measured at the duct downstream end. A total axial duct length (d₃) is measured between the duct upstream and downstream ends. An aspect ratio is defined as (h1+h2)/(2*d3) and is less than or equal to 0.5.

In another embodiment according to any of the previous embodiments, there are no shaft bearings mounted within an axial extent of the vane between the vane upstream and downstream ends.

In another embodiment according to any of the previous embodiments, the length ratio is less than or equal to 1.5.

In another embodiment according to any of the previous embodiments, the length ratio is greater than or equal to 0.8.

In another embodiment according to any of the previous embodiments, the length ratio is greater than or equal to 0.9 and less than or equal to 1.1.

In another embodiment according to any of the previous embodiments, a radially inner end of the duct upstream end defines a first point. A radially inner end of the duct downstream end defines a second point. An angle is defined between a line drawn between the first and second points, and a line drawn parallel to a center axis of the duct, and extending through the first point. The angle is greater than or equal to 10°.

In another embodiment according to any of the previous embodiments, the angle is greater than or equal to 15°.

In another embodiment according to any of the previous embodiments, the length ratio is greater than or equal to 0.9 and less than or equal to 1.1.

In another embodiment according to any of the previous embodiments, the length ratio is greater than or equal to 0.8.

In another embodiment according to any of the previous embodiments, a radially inner end of the duct upstream end defines a first point. A radially inner end of the duct downstream end defines a second point. An angle is defined between a line drawn between the first and second points, and a line drawn parallel to a center axis of the duct, and extending through the first point. The angle is greater than or equal to 10°.

In another embodiment according to any of the previous embodiments, the angle is greater than or equal to 15°.

In another featured embodiment, a gas turbine engine comprises a turbine section defining an upstream turbine rotor and a downstream turbine rotor. The downstream turbine rotor drives a fan through a gear reduction. A duct has a duct upstream end at a downstream end of the upstream turbine rotor, and a duct downstream end at an upstream end of the downstream turbine rotor. The duct includes a first gap extending between the duct upstream end of the duct and an upstream end of a vane positioned within the duct, intermediate the duct upstream and downstream ends. A second gap is defined between a downstream end of the vane and the duct downstream end. The first gap extends for a first distance and the second gap extends for a second distance. A length ratio of the first distance to the second distance is less than or equal to 2.0. A first bearing supports the upstream turbine rotor. A second bearing supports the downstream turbine rotor, with both the first and second bearings mounted axially outside of an axial dimension of the vane.

In another embodiment according to the previous embodiment, a first radial height (h₁) is measured at the duct upstream end. A second radial height (h₂) is measured at the duct downstream ends. A total axial duct length (d₃) is measured between the duct upstream and downstream ends. An aspect ratio is defined as (h1+h2)/(2*d3) and is less than or equal to 0.5.

In another embodiment according to any of the previous embodiments, the length ratio is less than or equal to 1.5.

In another embodiment according to any of the previous embodiments, the length ratio is greater than or equal to 0.8.

In another embodiment according to any of the previous embodiments, the length ratio is greater than or equal to 0.9 and less than or equal to 1.1.

In another embodiment according to any of the previous embodiments, a radially inner end of the duct upstream end defines a first point. A radially inner end of the duct downstream end defines a second point. An angle is defined between a line drawn between the first and second points, and a line drawn parallel to a center axis of the duct, and extending through the first point. The angle is greater than or equal to 10°.

In another embodiment according to any of the previous embodiments, the bearing supporting the upstream turbine rotor is radially inward of a combustor section. The bearing supporting the downstream turbine rotor is downstream of an upstream most blade on the downstream drive turbine rotor.

In another embodiment according to any of the previous embodiments, a radially inner end of the duct upstream end defines a first point, and a radially inner end of the duct downstream end defines a second point. An angle is defined between a line drawn between the first and second points, and a line drawn parallel to a center axis of the duct, and extending through the first point. The angle is greater than or equal to 10°.

In another embodiment according to any of the previous embodiments, the bearing supporting the upstream turbine rotor is radially inward of a combustor section. The bearing supporting the downstream turbine rotor is downstream of a downstream most blade on the downstream drive turbine rotor.

These and other features may be best understood from the following drawings and specification.

### BRIEF DESCRIPTION OF THE DRAWINGS

FIG. 1 schematically shows a gas turbine engine.

FIG. 2A schematically shows an aircraft style that may incorporate an engine such as disclosed in this application.

FIG. 2B schematically shows a detail of engine components.

FIG. 3 shows a detail of a mid-turbine duct.

### DETAILED DESCRIPTION

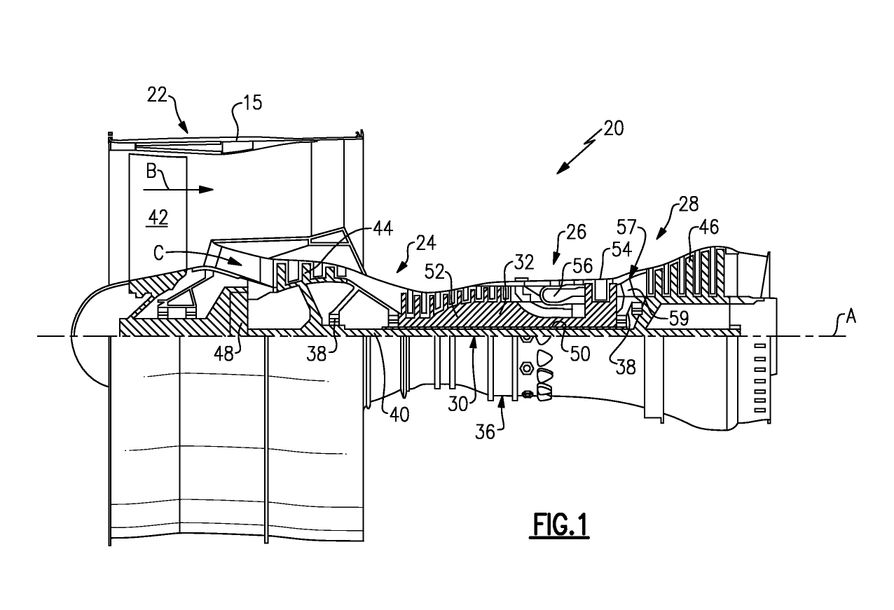

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram° R)/(518.7° R)]^{0.5}. The “Low corrected fan tip speed” as disclosed herein according to one non-limiting embodiment is less than about 1150 ft/second.

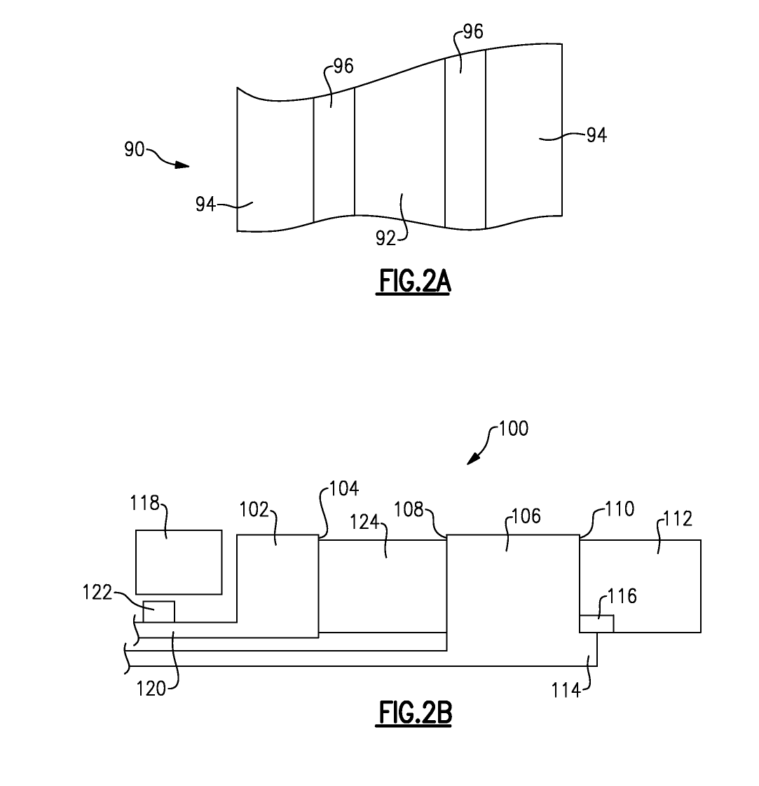

FIG. 2A shows a wide body aircraft 90. Such aircraft could be defined as having multiple aisles within the passenger section. As an example, there are laterally outward passenger sections 94 separated from a central passenger section 92 by a pair of aisles 96. These are typically larger aircraft. The engine as disclosed below has particular application in such an aircraft.

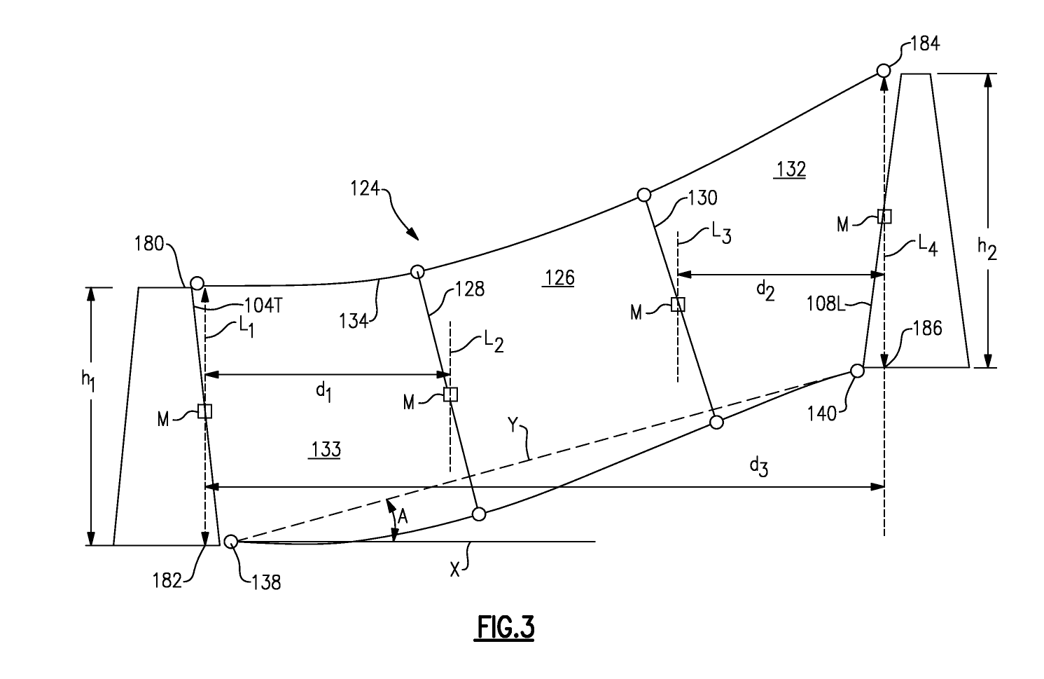

FIG. 2B shows a highly schematic view of a mount arrangement for turbine sections in an engine 100 which may be utilized on the aircraft 90. Engine 100 may be generally constructed like engine 20 of FIG. 1. As shown, a combustor section 118 is upstream of an upstream higher pressure turbine rotor 102. A downstream end 104 of the last blade in the turbine section 102 is spaced from an upstream end 108 of an upstream most blade of a fan drive or downstream lower pressure turbine rotor 106. An intermediate or mid-turbine duct 124 extends between the ends 104 and 108, and will be described below. A turbine exhaust structure 112 is downstream of a downstream end 110 of the fan drive turbine 106. As shown, a shaft 114 rotates with the turbine rotor 106 and includes a bearing 116 which is downstream of the downstream end 110. A bearing 122 mounts a shaft 120 which rotates with the higher pressure turbine rotor 102. Notably, the bearing 122 may be radially inward of the combustion section 118. It should be understood that the duct 124 can also be placed between two turbine rotors in an engine having three turbine rotors. In a gas turbine engine, such as gas turbine engine 100, there are no shaft bearings within the axial length of the duct 124 between its upstream and downstream ends. More particularly, there are no bearings within the axial extent of static vane 126 (see FIG. 3). Duct 124 is thus non-structural, and includes no mount structure, such as tie-rods extending radially through stationary vane 126 within the duct. The vane 126 itself is also non-structural.

A shaft bearing 122 supports the upstream turbine rotor 102, and a shaft bearing 116 supports the downstream turbine rotor 106. Both bearings 122 and 116 are mounted axially outside of an axial dimension of duct 124.

A mid-turbine duct 124, which may be utilized in the engine 100, is illustrated in FIG. 3. The downstream end 104 is shown leading into the duct 124. A gap area 133 is defined between the downstream end 104 of the downstream most blade in the high pressure turbine and an upstream end 128 of airfoils in a static vane 126. Gap 133 extends for a length d₁. The vane 126 extends to a downstream end 130. It should be understood there are a plurality of circumferentially spaced vanes. A second gap 132 is defined between end 130 of airfoils in the static vane 126 and an upstream end 108 of an upstream most blade in the fan drive turbine 106. As shown, the duct 124 also moves radially outwardly, such that an outer wall 134 curves outwardly as does an inner wall 136. An angle of outward movement could be defined between an axially upstream end 138 and an axially downstream end 140 of the duct 124.

While the disclosure specifically discloses a gas turbine engine 100 having two rotors 102 and 106, this disclosure may also have benefits in a gas turbine engine having three or more turbine rotors. The duct 124 constructed as disclosed may be positioned between any two serially arranged turbine rotors in such a gas turbine engine.

In sum, a disclosed duct 124 has a duct upstream end 104 that abuts a downstream end of an upstream turbine rotor 102. A duct downstream end 105 abuts an upstream end of a downstream turbine rotor 106. The duct includes a first gap 133 extending between the duct upstream end 104 and an upstream end 128 of a vane 126 positioned within duct 124 and intermediate the duct upstream and downstream ends 104 and 128. A second gap 132 is defined between a downstream end 130 of vane 126 and the duct downstream end 108. The first gap 133 extends for a first distance d₁ and second gap 132 extends for a second distance d₂. A ratio of first distance d₁ to second distance d₂ is less than or equal to 2.0.

The radially inner end 138 of duct upstream end 104 defines a first point, and a radially inner end 140 of duct downstream end 108 defines a second point. An angle A is defined between a line drawn between the first and second points, and a line X drawn parallel to a center axis of engine 100, and extending through the first point. Angle A is greater than or equal to 10°.

The distances d₁ and d₂ are axial distances that are measured between lines L₁ and L₂ (d₁) and L₃ and L₄ (d₂). The lines L₁-L₄ extend through a radial distance perpendicularly to the line X. Line L₁ extends between a radially outer point 180 and a radially inner point 182, and defined through a mid-span point M of the trailing edge 104T of the downstream most blade. The line L₂ is defined between the mid-span point M of the upstream end 128 of the vane 126. The line L₃ is defined through the mid-span point M of the downstream or trailing edge 130 of the vane 126. The line L₄ is defined through the mid-span point M of the leading edge 108 of the upstream most blade.

This disclosure places the vane 126 such that the axial length d₁ is much closer to the axial length d₂ than in the past. As an example, a length ratio of d₁ to d₂ is less than or equal to 2.0. More narrowly, the length ratio may be less than or equal to 1.5.

In embodiments, the length ratio is greater than or equal to 0.8. More narrowly, the length ratio may be between 0.9 and 1.1.

By having the vane closer to an axial center of the duct 124, the unconstrained flow length through the gap 133 is reduced, such that the flow is re-accelerated across the vane earlier in the flow process between the two turbine sections. This increases the efficiency of operation of the engine.

An aspect ratio of the duct 124 can also be defined by a radial height h₁ measured along line L₁ and between points 180 and 182. A second radial height h₂ is measured between points 184 and 186, and along line L₄. A total axial length d₃ is measured between lines L₁ and L₄. The aspect ratio is defined as follows: (h1+h2)/(2*d3).

In embodiments, the aspect ratio of the vaned duct is less than or equal to 0.5.

The aspect ratio of the duct 124 could be defined by a radial height h₁ measured at the duct upstream end 104, a second radial height h₂ measured at the downstream end 105 of the duct, and a total axial length d₃ measured between the ends 105 and 104. The aspect ratio is defined as follows: (h1+h2)/(2*d3) and wherein the aspect ratio is less than or equal to 0.5.

Although an embodiment of this invention has been disclosed, a worker of ordinary skill in this art would recognize that certain modifications would come within the scope of this invention. For that reason, the following claims should be studied to determine the true scope and content of this invention.

1. A mid-turbine vaned duct comprising:
a duct upstream end to abut a downstream end of an upstream turbine rotor, and a duct downstream end to abut an upstream end of a downstream turbine rotor;
said vaned duct including a first gap extending between said upstream turbine rotor and an upstream end of a vane positioned within said duct, intermediate said vaned duct upstream and downstream ends, a second gap defined between a downstream end of said vane and said downstream turbine rotor; and
said first gap extending for a first axial distance and said second gap extending for a second axial distance, and a length ratio of said first axial distance to said second axial distance being less than or equal to 2.0.

2. The mid-turbine vaned duct as set forth in claim 1, wherein a first radial height (h₁) is measured at said duct upstream end, a second radial height (h₂) is measured at said duct downstream end, a total axial duct length (d₃) is measured between the duct upstream and downstream ends, and an aspect ratio is defined as (h1+h2)/(2*d3) and wherein said aspect ratio is less than or equal to 0.5.

3. The mid-turbine vaned duct as set forth in claim 2, wherein there are no shaft bearings mounted within an axial extent of said vane between said vane upstream and downstream ends.

4. The mid-turbine vaned duct as set forth in claim 1, wherein said length ratio is less than or equal to 1.5.

5. The mid-turbine vaned duct as set forth in claim 4, wherein said length ratio is greater than or equal to 0.8.

6. The mid-turbine vaned duct as set forth in claim 5, wherein said length ratio is greater than or equal to 0.9 and less than or equal to 1.1.

7. The mid-turbine vaned duct as set forth in claim 2, wherein a radially inner end of said duct upstream end defines a first point, and a radially inner end of said duct downstream end defines a second point and an angle defined between a line drawn between said first and second points, and a line drawn parallel to a center axis of said duct, and extending through said first point, said angle being greater than or equal to 10°.

8. The mid-turbine vaned duct as set forth in claim 7, wherein said angle is greater than or equal to 15°.

9. The mid-turbine vaned duct as set forth in claim 8, wherein said length ratio is greater than or equal to 0.9 and less than or equal to 1.1.

10. The mid-turbine vaned duct as set forth in claim 1, wherein said length ratio is greater than or equal to 0.8.

11. The mid-turbine vaned duct as set forth in claim 1, wherein a radially inner end of said duct upstream end defines a first point, and a radially inner end of said duct downstream end defines a second point and an angle defined between a line drawn between said first and second points, and a line drawn parallel to a center axis of said duct, and extending through said first point, said angle being greater than or equal to 10°.

12. The mid-turbine vaned duct as set forth in claim 11, wherein said angle is greater than or equal to 15°.

13. A gas turbine engine comprising:
a turbine section defining an upstream turbine rotor and a downstream turbine rotor, said downstream turbine rotor driving a fan through a gear reduction;
a duct having a duct upstream end at a downstream end of said upstream turbine rotor, and a duct downstream end at an upstream end of said downstream turbine rotor;
said duct including a first gap extending between said duct upstream end of said duct and an upstream end of a vane positioned within said duct, intermediate said duct upstream and downstream ends, a second gap defined between a downstream end of said vane and said duct downstream end, and said first gap extending for a first distance and said second gap extending for a second distance, and a length ratio of said first distance to said second distance being less than or equal to 2.0; and
a first bearing supporting said upstream turbine rotor, and a second bearing supporting said downstream turbine rotor, with both said first and second bearings being mounted axially outside of an axial dimension of said vane.

14. The gas turbine engine as set forth in claim 13, wherein a first radial height (h₁) is measured at said duct upstream end, a second radial height (h₂) is measured at said duct, and a total axial duct length (d₃) is measured between the duct upstream and downstream ends, and an aspect ratio is defined as (h1+h2)/(2*d3) and wherein said aspect ratio is less than or equal to 0.5.

15. The gas turbine engine as set forth in claim 13, wherein said length ratio is less than or equal to 1.5.

16. The gas turbine engine as set forth in claim 13, wherein said length ratio is greater than or equal to 0.8.

17. The gas turbine engine as set forth in claim 16, wherein said length ratio is greater than or equal to 0.9 and less than or equal to 1.1.

18. The gas turbine engine as set forth in claim 17, wherein a radially inner end of said duct upstream end defines a first point, and a radially inner end of said duct downstream end defines a second point and an angle defined between a line drawn between said first and second points, and a line drawn parallel to a center axis of said duct, and extending through said first point, with said angle being greater than or equal to 10°.

19. The gas turbine engine as set forth in claim 18, wherein said bearing for supporting said upstream turbine rotor is radially inward of a combustor section, and said bearing for supporting said downstream turbine rotor is downstream of an upstream most blade on said downstream drive turbine rotor.

20. The gas turbine engine as set forth in claim 13, wherein a radially inner end of said duct upstream end defines a first point, and a radially inner end of said duct downstream end defines a second point and an angle defined between a line drawn between said first and second points, and a line drawn parallel to a center axis of said duct, and extending through said first point, with said angle being greater than or equal to 10°.

21. The gas turbine engine as set forth in claim 13, wherein said bearing for supporting said upstream turbine rotor is radially inward of a combustor section, and said bearing for supporting said downstream turbine rotor is downstream of an upstream most blade on said downstream drive turbine rotor.
